(19) United States
(12) Patent Application Publication
(10) Pub. No.: US 2002/0152266 A1
(43) Pub. Date: Oct. 17, 2002

(54) Method and apparatus for mobile personal radar

(76) Inventors: Craig R. Burfeind, Chanhassen, MN (US); Peter Resch, Albertville, MN (US); Anthony Case, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/834,160

(22) Filed: Apr. 12, 2001

(51) Int. Cl. G06F 15/16; H04Q 7/20

(52) U.S. Cl. 709/203; 455/457

(57) ABSTRACT

Systems and methods are provided through which a radar image centered on a location of interest, is displayed. Alternatively, other predetermined personal locations that are within the range of the radar display are also displayed in the radar image. The personal locations are stored in a database, and the location of interest is selected from the personal locations. The radar image is dynamic, and changes when a different location of interest is selected from the list of personal locations. In another embodiment, the location of interest is the current physical location of the computer.

### FIELD OF THE INVENTION

The present invention relates generally to client/server multimedia applications and more specifically to generation and distribution of personalized multimedia geo-temporal information.

### BACKGROUND OF THE INVENTION

In recent years, geo-temporal information has become increasingly important to people and organizations. Geo-temporal information includes natural-phenomenological information pertaining to a particular time period. Geo-temporal information includes also geographic information, such as road and/or traffic conditions, pertaining to a particular time period.

Natural-phenomenological data is collected almost instantaneously from numerous sources. For example, meteorological data is collected from a multitude of individual sites scattered across the world, such as airports, and hydrological data is collected from nearly all of the rivers in the United States. The U.S. National Weather Service maintains a network of approximately 150 Next Generation Weather Radar (NEXRAD) sites across the U.S. Consumer awareness in natural-phenomenological information has also increased as a result of increased participation in outdoor activities and increasingly damaging natural phenomena, such as hurricanes, tornadoes, floods and volcanic activity.

Furthermore, systems for electronic distribution of natural-phenomenological information are commonly available today. Such conventional systems typically include a computer software program running on a client computer that displays periodically reported natural-phenomenological information provided by the National Weather Service that is received through a direct telephone line dial-up connection or an Internet connection. The natural-phenomenological information conventionally includes past, present and forecast meteorological conditions for a number of specific geographic locations including meteorological measures of temperature, relative humidity, wind direction and speed, barometric pressure, wind chill, dew point, precipitation activity, cloud coverage, satellite images, radar images, aviation-related information, warnings and watches of dangerous natural phenomena such as floods, tornadoes, hurricanes, hail size, speed and direction of the movement of storm cells, wind gusts within storm cells, supercell type, avalanches, brush fires, and forecasts for the local geographic area and the geographic region. Natural-phenomenological information also includes tide cycles, hydrological measures of lakes and rivers, seismological reports and forecasts, ski area snow condition reports, and cosmological events such as sunrise, sunset, and moon phases.

Graphic images of current and/or forecast meteorological conditions are available. For example, the Weather Channel offers graphic images of current or forecast conditions for particular locations. The user enters a zip code or city name into a field in a browser window. A request for a graphic image of the current or forecast meteorological conditions of the zip code or city is sent to the server, and the server returns a graphic image of the meteorological conditions in the vicinity of the zip code or city. The graphic image has labels of large cities and interstate highways. However, the graphic image lacks personalization, such as labels of locations that have any special or personal significance to the user. Furthermore, the image is not centered on the zip code or city. Instead, the same image is used for all zip codes or cities within the boundaries of the image. The server generates a graphic image for a number of portions of the United States, in anticipation of requests. The server will later send the same graphic image for all requests pertaining to the zip code and cities within the boundaries of the image, upon arrival of a request.

The Internet service “MapQuest” enables a user to receive a map of an area that is centered on a location specified by the user. MapQuest also enables the user to zoom the image in and out on the location of interest. However, MapQuest does not include geo-temporal information, or labels of locations that have any special or personal significance to the user other than the location that the image is centered on. In addition, MapQuest does not provide an image of geo-temporal conditions.

For the reasons stated above, and for other reasons stated below which will become apparent to those skilled in the art upon reading and understanding the present specification, there is a need in the art for a system that generates a graphic image of geo-temporal information that is personalized to the needs of the receiver of the image. Examples of personalization include centering the image on a location of interest, zooming in and out on the location of interest, and labeling locations of interest to the requesting user in the image.

### SUMMARY OF THE INVENTION

The above-mentioned shortcomings, disadvantages and problems are addressed by the present invention, which will be understood by reading and studying the following specification.

The present invention enables delivery of personalized radar images to users. Personalization is embodied in the form of images centered over the user's home, or another location of interest, and includes other locations of interest to the user, drawn on the image, and enabling the image to be zoomed in and out in differing ranges.

A client forms a request for a image of geo-temporal information that is centered on a specified location of interest. Alternatively, the request also specifies other personal locations to be labeled in the image. The client sends the request to a first server. The server identifies portions of a base map image, a graphic image of geo-temporal information, and an overlay image that are centered on the location of interest, and that are within a range from the location of interest. The identified portions are combined into a combined image, and which the graphic data of the overlay image is more prominent than the graphic data of the geo-temporal image, and the data of the geo-temporal image is more prominent than the graphic data of the base map image. Later, combined image is modified to indicate the personal locations within the range of the combined image. Thereafter, the image is transmitted from the first server to the client.

The location of interest and personal locations may be identified in a location profile that is stored on second server, or specified in the request. One example of a location specified is the request is a current physical location of the client that is determined from the global positioning system (GPS), or an Internet service provider (ISP) of the client.

In one implementation, the images are formatted as raw graphic data that is not suitable for display by a conventional client computer. In this one implementation, the present invention also encodes the combined image into a graphic display format before transmitting the combined image.

In one example, the base map image includes well-known topographic landmarks, such as bodies of water. In varying examples, the geo-temporal information includes current and/or forecast geo-temporal information. In one example, the overlay image includes indications of major roadways.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF TILE DRAWINGS

FIG. 1 is a block diagram of the hardware and operating environment in which different embodiments of the invention can be practiced.

FIG. 2 is a diagram illustrating a system-level overview of an embodiment of the invention.

FIG. 3 is a flowchart of a method for a managing a personalized phenomenological display performed by a client according to an embodiment of the invention.

FIG. 4 is a flowchart of a method for obtaining a location of interest, performed by a client according to an embodiment of the invention.

FIG. 5 is a flowchart of a method for obtaining a location of interest, performed by a server according to an embodiment of the invention.

FIG. 6 is a flowchart of a method for managing personalized phenomenological graphic information performed by a server according to an embodiment of the invention.

FIG. 7 is a flowchart of a method for managing personalized phenomenological graphic information performed by a server according to an embodiment of the invention.

FIG. 8 is an illustration of images involved in managing a personalized phenomenological display on a computer-readable medium according to an embodiment of the invention.

FIG. 9 is an illustration of images involved in managing a personalized phenomenological display on a computer-readable medium according to an embodiment of the invention.

FIG. 10 is a block diagram of server apparatus classes for managing personalized geo-temporal graphic information performed, according to an embodiment of the invention.

FIG. 11 is a block diagram of a server apparatus class for managing locations, according to an embodiment of the invention.

FIG. 12 is a block diagram of a server apparatus class for managing a multiple index color model, according to an embodiment of the invention.

FIG. 13 is a block diagram of a server apparatus class for managing a color model structure, according to an embodiment of the invention.

### DETAILED DESCRIPTION OF THE INVENTION

In the following detailed description of embodiments of the invention, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

The detailed description is divided into five sections. In the first section, the hardware and the operating environment in conjunction with which embodiments of the invention may be practiced are described. In the second section, a system level overview of the invention is presented. In the third section, methods for an embodiment of the invention are provided. In the fourth section, a particular object-oriented Internet-based implementation of the invention is described. Finally, in the fifth section, a conclusion of the detailed description is provided.

### Hardware and Operating Environment

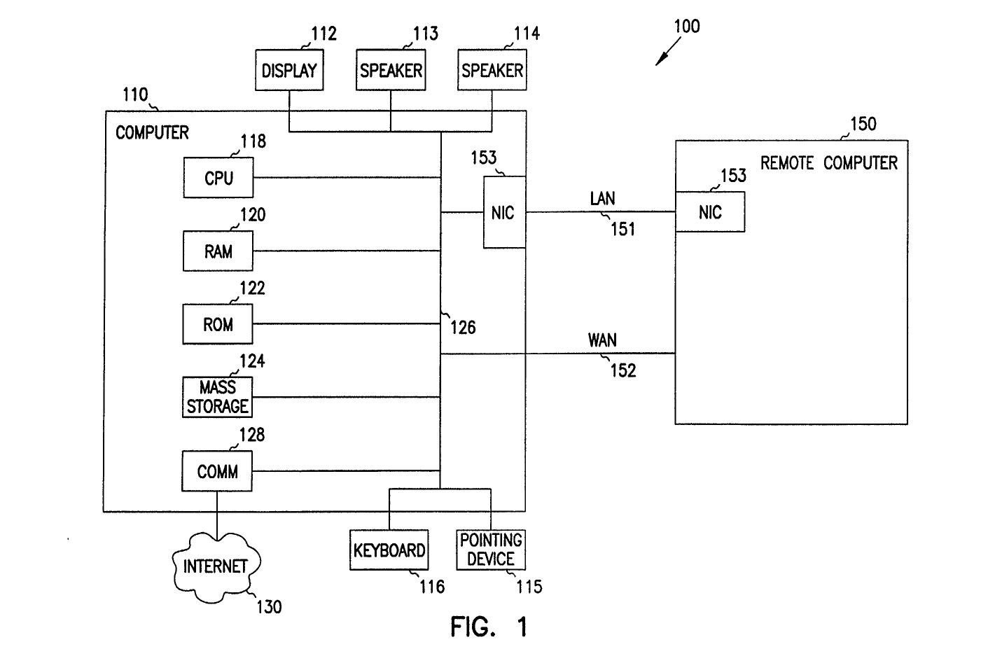

FIG. 1 is a block diagram of the hardware and operating environment 100 in which different embodiments of the invention can be practiced. The description of FIG. 1 provides an overview of computer hardware and a suitable computing environment in conjunction with which some embodiments of the present invention can be implemented. Embodiments of the present invention are described in terms of a computer executing computer-executable instructions. However, some embodiments of the present invention can be implemented entirely in computer hardware in which the computer-executable instructions are implemented in read-only memory. One embodiment of the invention can also be implemented in client/server computing environments where remote devices that are linked through a communications network perform tasks. Program modules can be located in both local and remote memory storage devices in a distributed computing environment.

Computer 110 is operatively coupled to display device 112, pointing device 115, and keyboard 116. Computer 110 includes a processor 118, commercially available from Intel®, Motorola®, Cyrix® and others, random-access memory (RAM) 120, read-only memory (ROM) 122, and one or more mass storage devices 124, and a system bus 126, that operatively couples various system components including the system memory to the processing unit 118. Mass storage devices 124 are more specifically types of nonvolatile storage media and can include a hard disk drive, a floppy disk drive, an optical disk drive, and a tape cartridge drive. The memory 120, 122, and mass storage devices, 124, are types of computer-readable media. A user enters commands and information into the computer 110 through input devices such as a pointing device 115 and a keyboard 116. Other input devices (not shown) can include a microphone, joystick, game pad, satellite dish, scanner, or the like. The processor 118 executes computer programs stored on the computer-readable media. Embodiments of the present invention are not limited to any type of computer 110. In varying embodiments, computer 110 comprises a PC-compatible computer, a MacOS®-compatible computer or a UNIX-compatible computer. The construction and operation of such computers are well known within the art.

Furthermore, computer 110 can be communicatively connected to the Internet 130 via a communication device 128. Internet 130 connectivity is well known within the art. In one embodiment, a communication device 128 is a modem that responds to communication drivers to connect to the Internet via what is known in the art as a “dial-up connection.” In another embodiment, a communication device 128 is an Ethernet or similar hardware (network) card connected to a local-area network (LAN) that itself is connected to the Internet via what is known in the art as a “direct connection” (e.g., T1 line, etc.).

Computer 110 can be operated using at least one operating environment to provide a graphic user interface including a user-controllable pointer. Such operating environments include operating systems such as versions of the Microsoft Windows® and Apple MacOS® operating systems well-known in the art. Embodiments of the present invention are not limited to any particular operating environment, however, and the construction and use of such operating environments are well known within the art. Computer 110 can have at least one web browser application program executing within at least one operating environment, to permit users of computer 110 to access intranet or Internet world-wide-web pages as addressed by Universal Resource Locator (URL) addresses. Such browser application programs include Netscape Navigator® and Microsoft Internet Explorer®.

Display device 112 permits the display of information, including computer, video and other information, for viewing by a user of the computer. Embodiments of the present invention are not limited to any particular display device 112. Such display devices include cathode ray tube (CRT) displays (monitors), as well as flat panel displays such as liquid crystal displays (LCD's). Display device 112 is connected to the system bus 126. In addition to a monitor, computers typically include other peripheral input/output devices such as printers (not shown), speakers, pointing devices and a keyboard. Speakers 113 and 114 enable the audio output of signals. Speakers 113 and 114 are also connected to the system bus 126. Pointing device 115 permits the control of the screen pointer provided by the graphic user interface (GUI) of operating systems such as versions of Microsoft Windows®. Embodiments of the present invention are not limited to any particular pointing device 115. Such pointing devices include mouses, touch pads, trackballs, remote controls and point sticks. Finally, keyboard 116 permits entry of textual information into computer 110, as known within the art, and embodiments of the present invention are not limited to any particular type of keyboard.

The computer 110 can operate in a networked environment using logical connections to one or more remote computers, such as remote computer 150. These logical connections are achieved by a communication device coupled to, or a part of, the computer 110. Embodiments of the present invention are not limited to a particular type of communications device. The remote computer 150 can be another computer, a server, a router, a network PC, a client, a peer device or other common network node. The logical connections depicted in FIG. 1 include a local-area network (LAN) 151 and a wide-area network (WAN) 152. Such networking environments are commonplace in offices, enterprise-wide computer networks, intranets and the Internet.

When used in a LAN-networking environment, the computer 110 and remote computer 150 are connected to the local network 151 through a network interface or adapter 153, which is one type of communications device. When used in a conventional WAN-networking environment, the computer 110 and remote computer 150 communicate with a WAN 152 through modems (not shown). The modem, which can be internal or external, is connected to the system bus 126. In a networked environment, program modules depicted relative to the computer 110, or portions thereof, can be stored in the remote memory storage device.

### System Level Overview

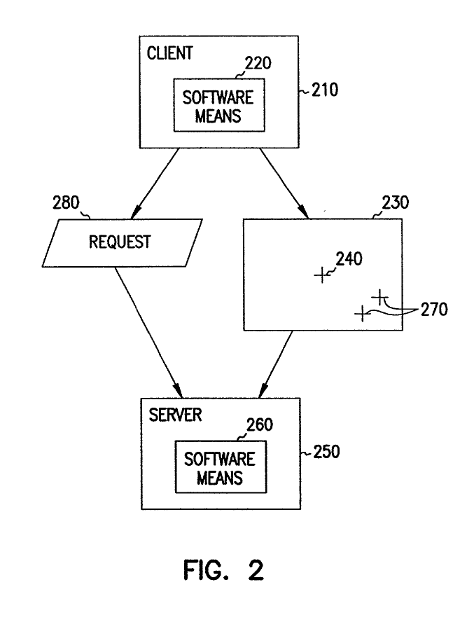

FIG. 2 is a block diagram that provides a system level overview of the operation of embodiments of the present invention. Embodiments of the invention are described as operating in a multi-processing, multi-threaded operating environment on a computer, such as computer 110 in FIG. 1.

System 200 includes a client computer 210 that includes software means 220 for obtaining an image 230 of geo-temporal information. The image 230 is centered on a location of interest 240. The client software means 220 is instrumental in obtaining the image 230 from the server 250. The image 230 is obtained through a command or request 280 to the server 250. Software means 260 on the server 250 generates an image 230 of geo-temporal information that is centered on the location of interest 240.

In another example, the image 230 includes one or more personal locations 270. Personal locations 270 are locations that have been identified as having special importance to the user of the system 200. In varying examples, the personal locations 270 are stored on the client 210 and/or the server 250, or a second server (not shown).

The geo-temporal information is forecast and/or current information pertaining to natural phenomena and/or travel route conditions.

The image 230 is centered on a location of interest 240. Centering the image 230 on a location of interest is useful to the user because locating the location of interest 240 in the image 230 is quicker, and therefore assessing the geo-temporal information relative to the position of the location of interest 240 in the image is faster. A centered location of interest 240 also reduces opportunity for error in visually identifying the location of interest in the image. In contrast to conventional systems, the present invention is useful because the user is enabled to identify those locations, 240 and 270, relative to each other and to the geo-temporal information in the image 230. Also having personal locations 230 integrated into the image 230 enables the user to quickly see and review the geo-temporal conditions of the locations, 240 and 270.

The server software means 260 initializes and loads base map data into memory (not shown) of the server 250. The server software means 260 periodically loads updated radar imagery into the memory, and responds to user hyper-text transfer protocol (HTTP) requests for localized and personalized portions of the imagery data.

The client software means 220 and the server software means 260 are operative on the client 210 and the server 250, respectively. System 200 also includes software means (not shown) for displaying the image 230 of geo-temporal information, operably coupled to the software means 220.

The system level overview of the operation of an embodiment of the invention has been described in this section of the detailed description. A system for requesting and generating images of personalized geo-temporal information. While the invention is not limited to any particular location of interest, software means, image, client and/or server, for sake of clarity, a simplified location of interest, software means, image, client and/or server has been described.

### Methods of an Embodiment of the Invention

In the previous section, a system level overview of the operation of an embodiment of the invention was described. In this section, the particular methods performed by the server and the clients of such an embodiment are described by reference to a series of flowcharts. Describing the methods by reference to a flowchart enables one skilled in the art to develop such programs, firmware, or hardware, including such instructions to carry out the methods on suitable computerized clients (the processor of the clients executing the instructions from computer-readable media). Similarly, the methods performed by the server computer programs, firmware, or hardware are also implemented as computer-executable instructions. Methods 300-700 are performed by a client program executing on, or performed by firmware or hardware that is a part of, a computer, such as computer 110 in FIG. 1.

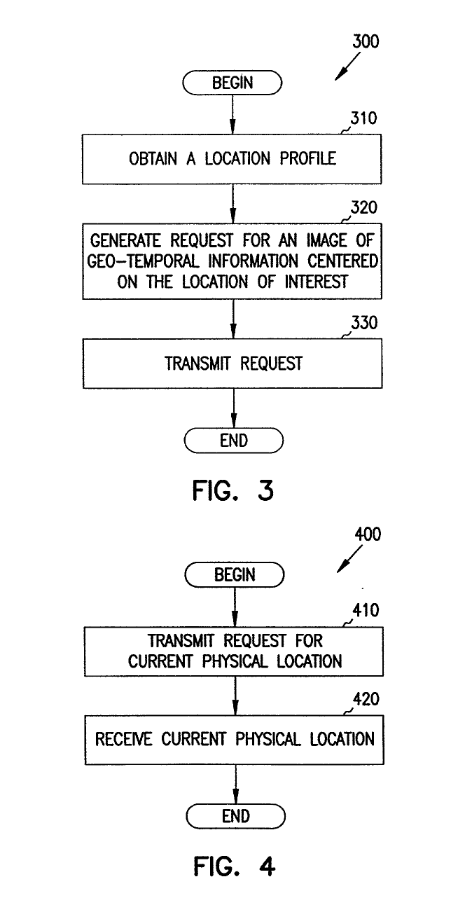

FIG. 3 is a flowchart of a method 300 for a managing a personalized phenomenological display performed by a client according to an embodiment of the invention.

Method 300 fulfills the need in the art for a client obtaining a graphic image of geo-temporal information that is personalized to the needs of the user of the image.

Method 300 includes obtaining a location profile 310. The location profile contains a location of interest, and optionally, one or more personal locations. Obtaining a location of interest is discussed in detail in methods 400 and 500.

Thereafter, a request is generated 320 for a graphic image of geo-temporal information centered on the location of interest. The location of interest may be defined in reference to longitude and latitude or the location of interest may be defined in reference to the name of the geopolitical position, such as a city. Alternatively, the location of interest may be a current physical location of an electronic device.

The request may include one or more indications of predetermined personal locations. The personal locations may be explicitly identified in the request. Alternatively, the personal locations may be stored on a server, and the personal locations are referenced by the request, such as by using an address of the storage location of the personal locations, or some other unique identification of the personal locations. In another example the personal locations are associated through identification of the user.

In one example, of the request, the request is implemented as an HTTP GET request.

The request may be for an image encoded in Joint Photographic Experts Group (JPEG) format, GIG format, or Portable Network Graphics (PNG) format. The request may be for a static image or a looping image. In the instance of looping images, the request may be for an animated graphics interchange format (GIF) format image. Furthermore, the request may be for an image encoded in a JAVA applet, a browser plug-in such, as Flash® or Shockwave®, or some other browser-based application.

Subsequently, the request is transmitted 330 to a server through a network, such as the Internet.

Thereafter, the geo-temporal information is received, and displayed on a display component associated with the electronic device. Where the client is a personal computer, such as computer 110 in FIG. 1, the geo-temporal information may be displayed on a display device 112 in FIG. 1, and through a web browser application program, such as Netscape Navigator® or Microsoft Internet Explorer®.

Method 300 fulfills the need in the conventional systems for obtaining a graphic image of geo-temporal information that is personalized to the needs of the user of the image as centered on a location of interest of the user, and/or labeled with locations of interest of the user.

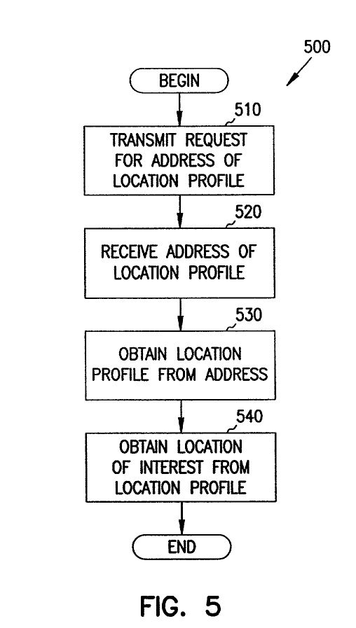

FIG. 4 is a flowchart of a method 400 for obtaining a location of interest, as in 310 in FIG. 3, performed by a client according to an embodiment of the invention. In method 400, the location of interest is the current physical location of the electronic device that performs method 400.

Method 400 is one alternative in obtaining a location of interest 310 in FIG. 3.

Method 400 includes transmitting 410 a request for an indication of the current physical location of the electronic device to the server. Thereafter, the indication of the current physical location of the electronic device is received 420 from the server.

In method 400, the electronic device is associated with and/or operated by a user, in which the user is interested in geo-temporal information related to the physical location of the user.

The electronic device can be a mobile electronic device, or a handheld electronic device, such as a cell phone or a wireless personal communication system (PCS) phone.

In yet another example, the handheld electronic device includes a wireless digital assistant device that is operably coupled to the Internet, such as a Palm manufactured by Palm Inc., an Audrey manufactured by 3com, and/or a Pocket PC by Microsoft Corp. In one example of the wireless digital assistant device, obtaining a current physical location of an electronic device includes sending a request for an indication of the proximate or specific, current physical location of the electronic device to a server, and receiving the indication of the location of the electronic device from the server. In one example, the server is a component of an Internet Service Provider (ISP) of the wireless digital assistant device. In another example where the global positioning system (GPS) is used to determine the current physical location of the device, the server is a GPS server.

Where the wireless digital assistant device is a Palm VII, communication with the ISP is implemented using the Palm Query Application (PQA) format. A location-related keyword, such as “zipcode” is transmitted from the Palm to the ISP in PQA format, the keyword is translated by the ISP, and the value of the zip code of the nearest base station to the Palm VII is returned to the Palm VII. The distance between the Palm VII and the nearest base station is typically within five to ten miles of the Palm VII.

The electronic device may also be a fixed-location, non-mobile, electronic device that has a unique identification code. Where the device is operably coupled to the Internet, an example of a unique identification code is an Internet Protocol (IP) address. Furthermore, obtaining a current physical location of an electronic device includes retrieving the Internet Protocol address of the fixed-location electronic device, and obtaining a current physical location of the electronic device from the IP address. In one example, obtaining a current physical location of the electronic device from the Internet Protocol address includes retrieving the current physical location of the electronic device from a database using the IP address as a key into the database, where the database is implemented on the fixed-location (non-mobile) electronic device, on a local-area network that the device is operably coupled to, or on another device that that fixed-location (non-mobile) electronic device is operably coupled to through a wide-area-network, such as the Internet.

FIG. 5 is a flowchart of a method 500 for obtaining a location of interest in a location profile, as in 310 in FIG. 3, performed by a first server according to an embodiment of the invention. In method 500, the location profile is stored local to a second server.

Method 500 is another alternative in obtaining a location of interest.

Method 500 includes transmitting 510 a request from the first server to the second server, for an address of the location profile. Thereafter, the address of the location profile is received 520 by the first server from the second server. In one example the address is a uniform resource locator (URL).

Thereafter, the first server obtains the location profile 530 using the address that was received in action 520. The location profile is obtained by generating and transmitting a request to the second server for the location profile, and receiving the location profile. In an embodiment where method 500 is implemented on a server that is operably coupled to a client that implements method 300, obtaining a location profile 310 in FIG. 3, is not performed by the client, but is instead performed by the first server in response to receiving the request from the client.

Subsequently, the location profile is obtained using the received address. The received address is used to formulate a request for the location profile. The request is transmitted to the second server, and the location profile is received by the first server.

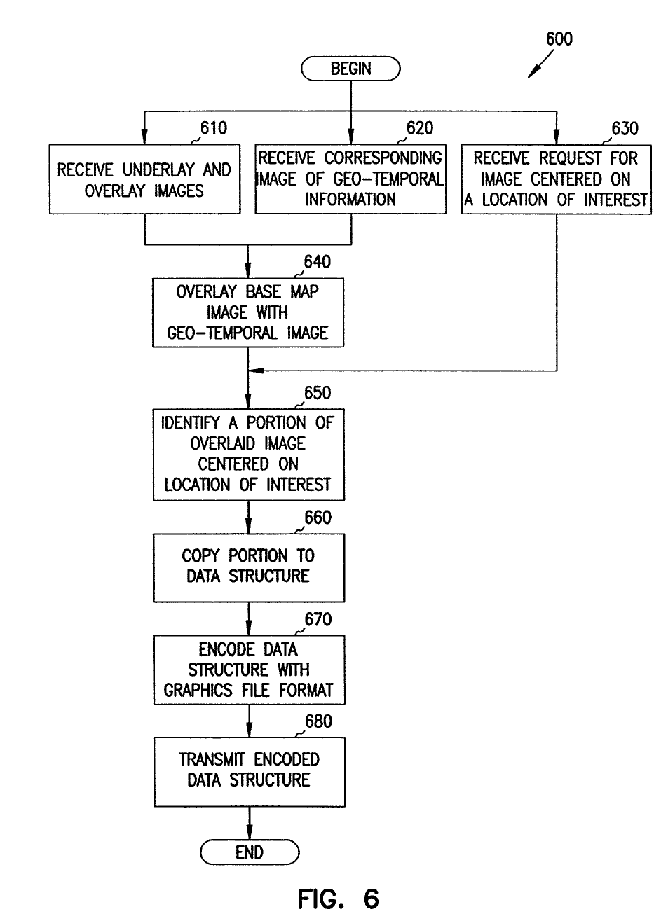

FIG. 6 is a flowchart of a method 600 for managing personalized phenomenological graphic information performed, by a server according to an embodiment of the invention.

Method 600 fulfills the need in the art of a graphic image of geo-temporal information that is personalized to the needs of the user of the image.

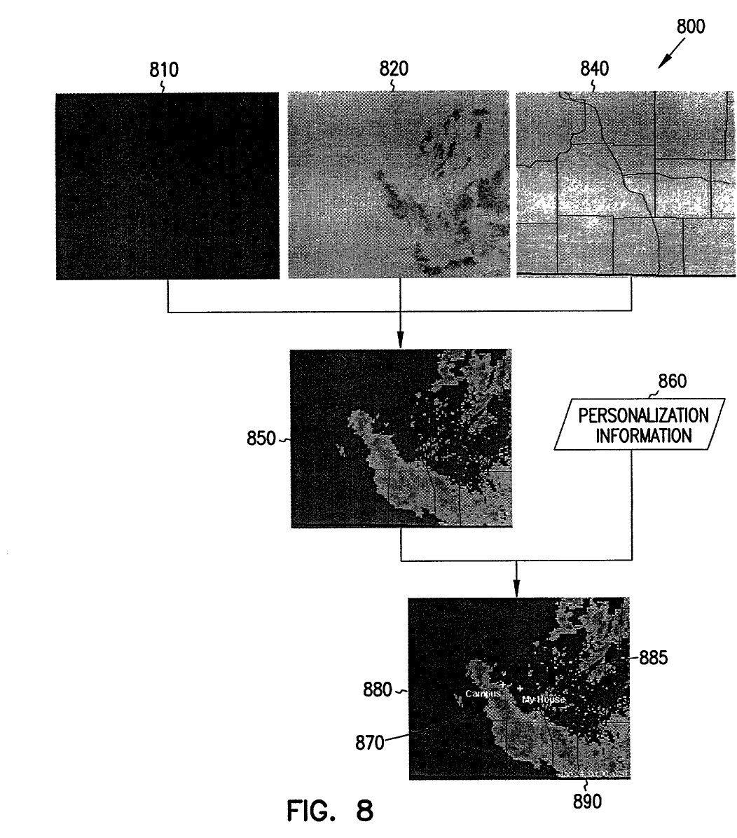

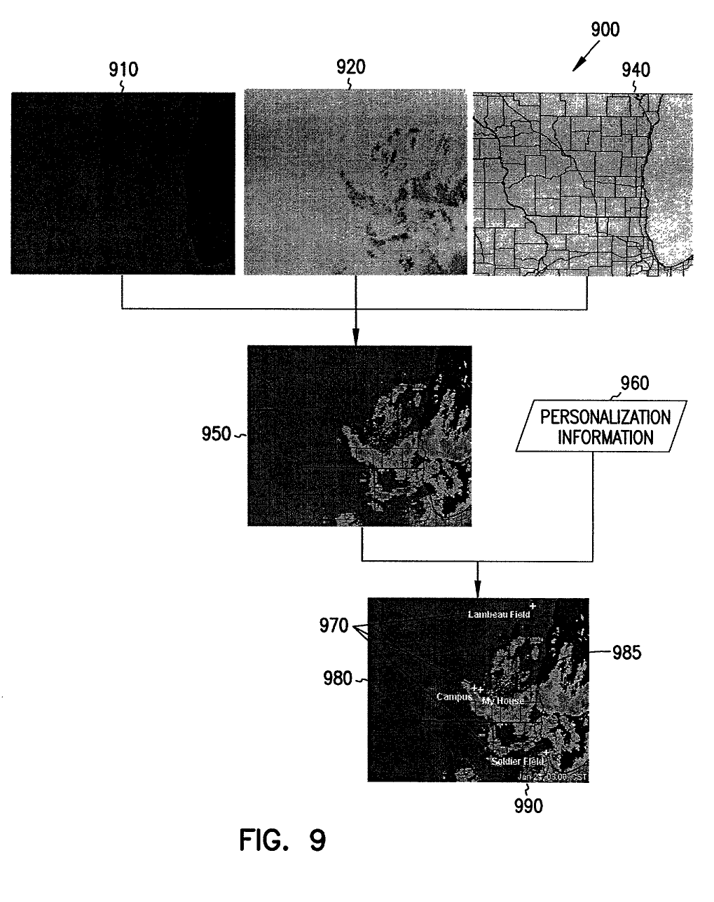

Method 600 includes receiving a base map image 610 of a geographic area, such as a base map of the United States of America. The base map image includes well-known topographic landmarks, such as bodies of water. The base map is depicted as image 810 in FIG. 8 and image 910 in FIG. 9.

Method 600 also includes receiving a graphic image of geo-temporal information that corresponds to the base map image 620. In varying examples, the geo-temporal information is current and/or forecast geo-temporal information.

A request for a graphic image of geo-temporal information is received 630. The request expressly indicates, or is interpreted to indicate, that geo-temporal information centered on a location of interest, within a physical distance range of the location of interest, is requested. In other examples, the request is embodied as a command or instruction. In further examples, the request is for a singular graphic image of geo-temporal information, or the request is for periodic transmissions of at least one graphic image of geo-temporal information.

In varying embodiments, receiving the graphic image 620 of geo-temporal information is performed before, during, and/or after the receiving the base map image 610.

After receiving the images in actions 610 and 620, the graphic image of geo-temporal information is combined with the base map image 640. The combining yields a combined graphic image data structure. In other examples, the combining action is overlaying and/or boolean adding of the images.

In one example, receiving the request 630 is performed before the combining 640. In other examples, receiving the request 630 is performed during and/or after the combining 640. However, in all situations, the request is received 630 before the method progresses past the combining 640.

After combining the images, method 600 includes identifying a portion of the combined graphic image that corresponds to the location of interest and the physical distance range 650. The request that is received in action 630 is the source of the location of interest. The source of the distance range, in varying examples, is the request, or a data source operably coupled to the server. In the example of the data source operably coupled to the server, the distance range may be a uniform distance range that is used for all requests, or the distance range may be associated with the user. The user may also more generally be a unique identification of the source of the request.

In one example, where the base map image and the graphic image are in the form of raw image data, not formatted for display, the portion is encoded with a graphics file format 670, and the encoded data structure is transmitted 680.

In one example of transmitting 680, the encoded data structure is transmitted to the source/sender of the request. In other examples where the encoded data structure is periodically transmitted, the periodic transmission is performed at a predetermined time period and/or when certain geo-temporal information exceeds one or more predetermined trigger/threshold values.

In one variation of method 600, the request includes indications of predetermined personal locations, within the physical distance range of the location of interest, and method 600 includes modifying the portion with labels that indicate the personal locations. In varying embodiments, the indications of predetermined personal locations include names, longitude and latitude locations, and/or keys into lists or tables of personal locations that are stored local to the server.

In another variation, method 600 includes encoding the data structure with a graphics file format. The encoding is performed after the overlying 640. In one example, an indication of the graphics file format is included in the request. In another example, the server that performs method 600 is dedicated to serving a specific type of device, or class of devices, that originated the request. The device or class of devices share at least one characteristic in common: the requirement and/or ability to support a particular graphics file format. The particular graphics file format is predetermined before the operation of method 600, and the particular graphics file format used in the encoding.

In yet another variation, the identifying action 650 includes identifying a portion of the combined graphic image, the portion having a center corresponding to the location of interest, and the portion having an outer boundary corresponding to the physical distance range from the center.

In still another embodiment, the actions of receiving a geo-temporal image 620, overlying 640, identifying 650, copying 660, encoding 670 and transmitting 680 are performed repeatedly in response to a request received in action 630 for periodic updates and/or update when specific geo-temporal information exceeds a threshold value.

Method 600 fulfills the need of the conventional systems for obtaining a graphic image of geo-temporal information that is personalized to the needs of the user of the image as centered on a location of interest of the user, and labeled with locations of interest of the user.

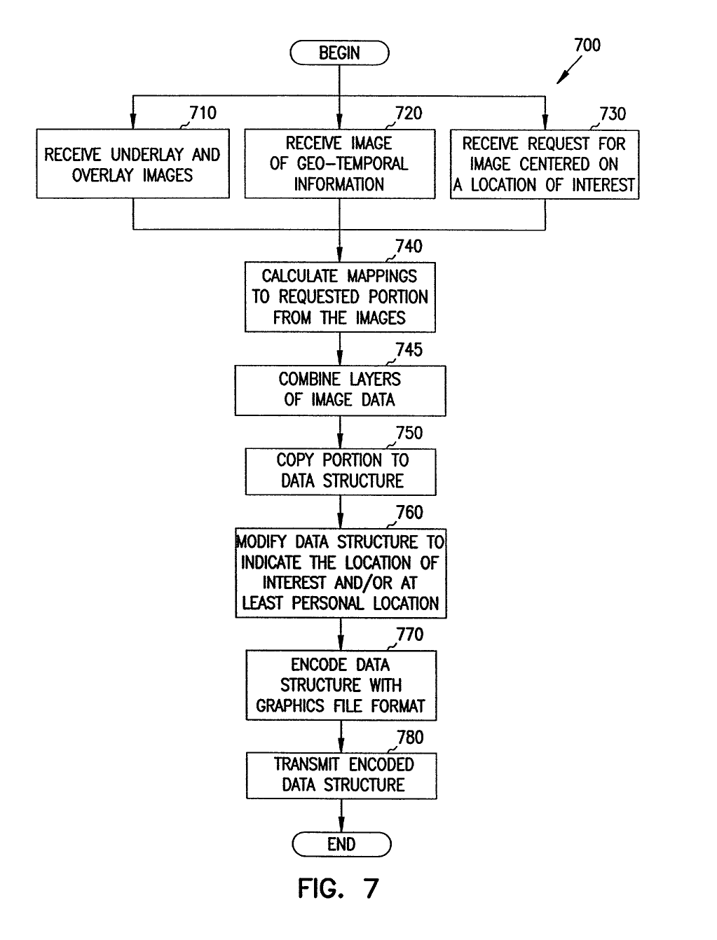

FIG. 7 is a flowchart of a method 700 for managing personalized phenomenological graphic information performed, by a server according to an embodiment of the invention.

Method 700 fulfills the need in the art of a graphic image of geo-temporal information that is personalized to the needs of the user of the image.

Method 700 includes receiving a base map image 710 of a geographic area, such as a base map of the United States of America. The base map image includes well-known topographic landmarks, such as bodies of water. The base map is depicted as image 810 in FIG. 8 and image 910 in FIG. 9.

Method 700 also includes receiving a graphic image of geo-temporal information that corresponds to the base map image 720. In varying examples, the geo-temporal information is current and/or forecast geo-temporal information. The graphic image of geo-temporal information is depicted as image 820 in FIG. 8 and image 920 in FIG. 9.

A request for a graphic image of geo-temporal information is received 730. The request expressly indicates, or is interpreted to indicate, that geo-temporal information centered on a location of interest, within a physical distance range of the location of interest, is requested. In other examples, the request is embodied as a command or instruction. In further examples, the request is for a singular graphic image of geo-temporal information, or the request is for periodic transmissions of at least one graphic image of geo-temporal information.

In varying embodiments, receiving the graphic image 720 of geo-temporal information is performed before, during, and/or after receiving 710 the base map image.

After receiving the images in actions 710 and 720, the graphic image of geo-temporal information is combined with the base map image 740. The combining yields a first combined graphic image data structure. The geo-temporal information is integrated prominently in the hierarchy of the overlay because the geo-temporal information is prominent in the interest of the user. In other examples, the combining action is combining and/or boolean adding of the images. The graphic image of geo-temporal information is depicted as image 820 in FIG. 8 and image 920 in FIG. 9. The geo-temporal information is integrated prominently in the hierarchy of the overlay because the geo-temporal information is prominent in the interest of the user.

After generating the first combined image, a second combined image is created 745 from the first combined image and an image of geo-political information. Geopolitical information includes state and international boundaries, and roads. The image of geo-political information is depicted as image 840 in FIG. 8 and image 940 in FIG. 9. The second combined graphic image is depicted as image 850 in FIG. 8 and image 950 in FIG. 9. . The geo-political information is integrated more prominently in the hierarchy of the overlays because the geopolitical information is typically necessary in order for the user to visually determine the position of the geo-temporal information.

In one example, receiving the request 730 is performed before the combining action 740 or the combining action 745. In other examples, receiving the request 730 is performed during and/or after the combining 740 or combining 745. However, in all situations, the request is received 730 before the method progresses past the combining 745.

After combining the images, method 700 includes identifying a portion 750 of the second combined graphic image that is centered on the location of interest, and having a physical distance range. The source of the location of interest is the request that was received in action 730. The source of the distance range of the portion, in varying examples, is the request received in action 730, or a data source operably coupled to the server. In the example of the data source operably coupled to the server, the distance range may be a uniform distance range that is used for all requests, or the distance range may be associated with the user. The user may also more generally be a unique identification of the source of the request.

Subsequently, the identified portion is copied to a data structure 760 in preparation for final processing.

Thereafter, the data structure is modified with personalization information 765, such as the location of interest, personal locations and/or a localized date/time stamp. The personalization information is depicted as data 860 in FIG. 8 and data 860 in FIG. 9.

Subsequently, in one example, where the base map image and the graphic image are in the form of raw image data, not formatted for display, the portion is encoded with a graphics file format 770, and the encoded data structure is transmitted 780.

In one example of transmitting 780, the encoded data structure is transmitted to the source/sender of the request. In other examples where the encoded data structure is periodically transmitted, the periodic transmission is performed at a predetermined time period and/or when certain geo-temporal information exceeds one or more predetermined trigger/threshold values.

In one variation of method 700, the request includes indications of predetermined personal locations, within the physical distance range of the location of interest, and method 700 includes modifying the portion with labels that indicate the personal locations. In varying embodiments, the indications of predetermined personal locations include names, longitude and latitude locations, and/or keys into lists or tables of personal locations that are stored local to the server.

In another variation, method 700 includes encoding the data structure with a graphics file format. The encoding is performed after the overlying 740. In one example, an indication of the graphics file format is included in the request. In another example, the server that performs method 700 is dedicated to serving a specific type of device, or class of devices, that originated the request. The device, or class of devices, share at least one characteristic in common: The requirement and/or ability to support a particular graphics file format. The particular graphics file format is predetermined before the operation of method 700, and the particular graphics file format used in the encoding.

In yet another variation, the identifying action 750 includes identifying a portion of the combined graphic image, the portion having a center corresponding to the location of interest, and the portion having an outer boundary corresponding to the physical distance range from the center.

Method 700 fulfills the need of the conventional systems for obtaining a graphic image of geo-temporal information that is personalized to the needs of the user of the image as centered on a location of interest of the user, and labeled with locations of interest of the user.

According to yet another embodiment of a method of the invention, the location of a mobile device, and in particular a WAP-enabled mobile phone, is determined by what cell of a cell phone system the mobile phone is currently being serviced by. In one such example embodiment, the cell phone system produces location data that is supplied to the user's cell phone. This location data for example is the zip code of the area that the user is most likely in or proximate to while using the mobile phone, as determined by the phone system cell providing service to the mobile phone. As the user passes from one cell to the next while traveling, the zip code location is in turn updated to the mobile phone. In this example embodiment, the zip code is in turn used by the mobile phone to automatically inform the personal weather server of the location of the mobile phone. In this manner, the personal weather feed to the mobile device may be continuously updated automatically as the user's location changes.

According to yet other example embodiments, the same approach is used in the case of a personal digital assistant adapted for wireless Internet access. In such systems using cell technology, the same type of approach is applied, allowing the location of the personal digital assistant to be automatically fed to the assistant by determination of the cell that the digital assistant is being serviced by for wireless Internet service. In still other example embodiments, the cell telephone system or wireless Internet service provider provides the user's location directly to the personal weather server, as opposed to routing such information through the mobile phone or digital assistant.

In yet other example embodiments, the location of the mobile device using a cell phone system infrastructure is determined by the process of triangulation, in which the signal strength or other characteristic of the mobile device transmissions ar measured at the receivers of several different cell site installations and the relative comparison of the signals allows the location of the device to be more accurately determined.

In still another example embodiment, the mobile device includes a global positioning system that can determine the location of the mobile device by reference to GPS satellites. The location is determined at the mobile device, and in turn reported to the personal weather server. This approach allows a highly accurate determination of the mobile device's location using widely available technology.

In yet another example embodiment, the mobile device is itself a GPS unit that is wireless enabled allowing for wireless communication to the personal weather server either through a private network or the Internet. This device includes a display, typically an LCD, for displaying the user's location and other location-related data to the user. In one embodiment, the display is a text-based display for displaying location coordinates and other statistics. In another embodiment, it is a graphical display that can display a map showing the user's location or another area of interest to the user.

In this example embodiment, the wireless GPS unit can be used to request personal weather maps for any area of interest to the user, but in particular the unit can display a continuously updated weather map that is centered on the user's current location or otherwise oriented to show the weather conditions from the unique geographical location of the user. The continuously or periodically updated map would be recentered or reoriented taking into account changes in the user's location as determined by the GPS circuits. Further, in one example embodiment, the speed and direction of the user is determined and used to determine the estimated time of arrival of the user to a storm system or other meteorological condition or event of interest. For example, the wireless GPS unit may report to the user that they are going to arrive upon a thunderstorm within a certain period of time, and thus allow the user to take precautionary steps or avoid the storm altogether. Of course, this same functionality may be provided using other mobile devices such as a WAP-enabled phone as described above provided that the device's location can be automatically determined in a sufficient manner.

In yet other example embodiments, the above-described functions may be obtained by the user manually entering their location information into the mobile device, such as a mile marker on a freeway, and providing the user's rate of speed and direction. Using this information, any weather conditions or events the user may be approaching can also be brought to the user's attention.

In other embodiments of the methods, the methods are implemented as a computer data signal embodied in a carrier wave, that represents a sequence of instructions which, when executed by a processor, such as processor 118 in FIG. 1, that cause the processor to perform the respective implemented methods.

### Implementation

Referring to FIGS. 8-13, implementations of the invention are described in conjunction with the system overview in FIG. 2 and the methods described in conjunction with FIGS. 300-700.

FIG. 8 is an illustration of images 800 involved in managing a personalized phenomenological display on a computer-readable medium according to an embodiment of the invention.

The present invention combines graphic data that represents a base map image of well-known landmarks 810 with overlying graphic data that represents geo-temporal information 820 and with overlying image 840, yielding a combined image 850. Subsequently, the combined image 850 is modified with personalization information 860, such an indication of the location of interest 885. A portion of the combined graphic data, having as it's center a location of personal interest 860 to the user, is copied from the combined graphic data. In the illustrated example 800, the location of personal interest 885 to the user is “My House.” The result is a data structure 880 that is personalized to the geo-temporal information needs of the user.

In another embodiment, the data structure 880 is modified with graphic data representing at least one personal location 870. In the illustrated example 800, the personal location 870 is “Campus.” The result is a data structure 880 that is similarly personalized to the geo-temporal information needs of the user.

In yet another embodiment, the data structure 880 is modified with graphic data representing a date/time stamp 890. In the illustrated example 800, the date/time stamp 890 is located in the bottom right-hand corner of the image 880.

In yet another embodiment, data structure 880 is the product of the process of method 700.

FIG. 9 is an illustration of images 900 involved in managing a personalized phenomenological display on a computer-readable medium according to an embodiment of the invention. FIG. 9 illustrates the images involved in a process that is substantially similar to the illustration of FIG. 8, but using a wider range, or field of view, than FIG. 8.

The present invention combines graphic data that represents a base map image of well-known landmarks 910 with overlying graphic data that represents geo-temporal information 920 and with overlying image 940, yielding a combined image 950. The combining of images 910 and 920 is described in combining 740 in FIG. 7. Overlay image 940 includes graphic geo-political and/or road information. The combining of images 910, 920 and 940 is described in combining 745 in FIG. 7. Subsequently, the combined image 950 is modified with personalization information 960, such as indications of the location of interest. The modification of image 950 with personalization information 960 is described in the modifying action 765 in FIG. 7. A portion of the combined graphic data, having as it's center a location of personal interest 960 to the user, is copied from the combined graphic data. In the illustrated example 900, the location of personal interest 960 to the user is “My House.” The result is a data structure 980 that is personalized to the geo-temporal information needs of the user.

In another embodiment, the data structure 980 is modified with graphic data representing at least one personal location 970. In the illustrated example 900, the personal locations 970 are “Campus,” “Soldier Field” and “Lambeau Field.” The result is a data structure 980 that is similarly personalized to the geo-temporal information needs of the user as data structure 880. The modification of image 950 with personalization information 960 is described in the modifying action 765 in FIG. 7.

In yet another embodiment, the data structure 980 is modified with graphic data representing a date/time stamp 990. In the illustrated example 900, the date/time stamp 990 is located in the bottom right-hand corner of the image 980.

In yet another embodiment, data structure 980 is the product of the process of method 700.

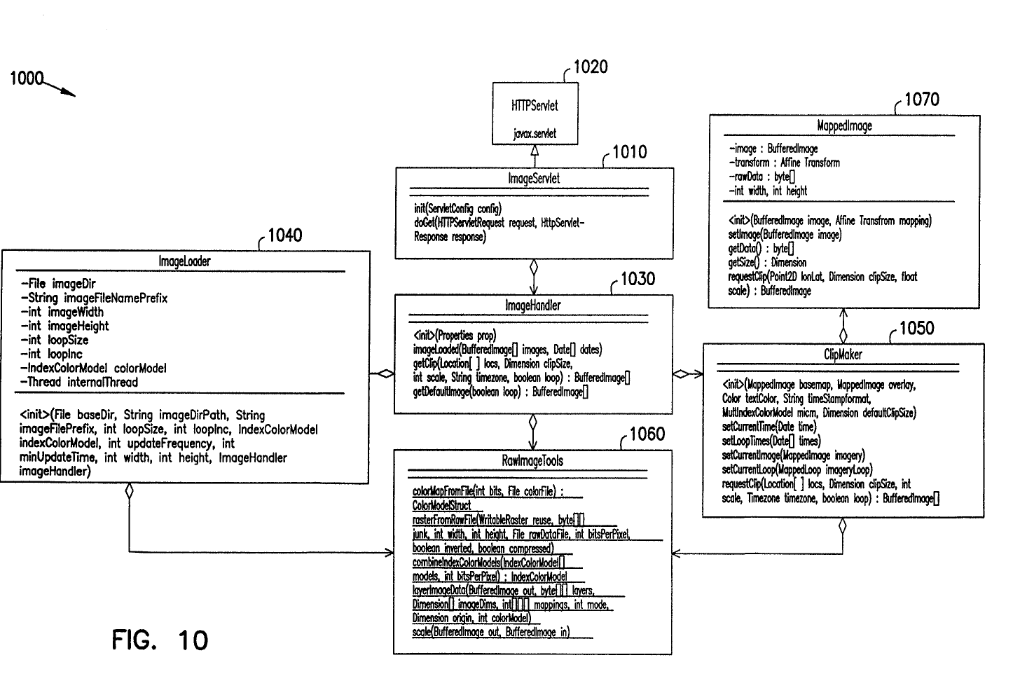

FIG. 10 is a block diagram of server apparatus classes 1000 for managing personalized geo-temporal graphic information performed, according to an embodiment of the invention.

The block diagram of server apparatus classes 1000 depicts the class relationships in a single instance of the server apparatus objects 1000. The server apparatus classes 1000 are implemented as a Java program, operating in a single Java virtual machine.

The server apparatus classes 1000 have the following basic functions: Initialization and loading of base map data, as in image 810 in FIG. 8 and image 910 in FIG. 9, into program memory, followed by periodic loading of new radar imagery into memory, and responding to user hyper-text transfer protocol (HTTP) requests for localized and personalized portions of the imagery data.

In the class diagram 1000, each box generally corresponds to one or more instances, or objects, of the named class. The box contents consist of the class name, e.g. “ImageServlet”, followed by a line and then a list of member variables that are prefixed by a dash. The member variables are the data of the object. Below a double line is a list of class methods. The methods are functions of the object. Class diagram 1000 shows public class methods, i.e. each class's public interface. The lines between the objects in diagram 1000 define the relationship between the objects. Class diagram 1000 uses the Unified Modeling Language (UML) notation, which is the industry-standard language for specifying, visualizing, constructing, and documenting the object-oriented artifacts of software systems. In the figures, a hollow arrow between classes is used to indicate that a child class below a parent class inherits attributes and methods from the parent class. In addition, a hollow diamond is used to indicate that an object of the class that is closest to the hollow diamond is composed of the other object connected through a line. Composition defines the attributes of an instance of a class as containing an instance of one or more existing instances of other classes in which the composing object does not inherit from the object(s) it is composed of.

The diagram depicts public interfaces of the server apparatus classes 1000. Managing varying maps sizes allows the system to display various scales of the requested image with aesthetic base map images, as in image 810 in FIG. 8 and image 910 in FIG. 9. Recycling of objects leads to faster server performance. Multiple image types refers to creating images for devices which support other image type, such as Palm devices, which support only four colors.

The ImageServlet class 1010 extends Java's HTTPServlet class 1020. The purpose of the ImageServlet class 1010 is to serve HTTP GET and POST requests. The ImageServlet class 1010 init( ) class method is invoked by the web server. The web server is external to the apparatus classes depicted. A “configuration” parameter of the init( ) class method contains the path to a properties file (not shown) of the server apparatus. The properties file contains configuration information in the server. The configuration information is used to initialize objects of the ImageServlet class 1010. Object of the ImageServlet class 1010 loads the configuration information into a Properties object (not shown), which Properties object uses to create an object (not shown) of the ImageHandler class 1030.

An object (not shown) of the ImageHandler class 1030 manages an object (not shown) of the ImageLoader class 1040. The object of the ImageLoader class 1040 loads periodic new radar images, and an object of the ClipMaker class 1050 constructs clips requested by the user. The object of the ImageHander class 1030 is instantiated with a Properties object that contains all the necessary information to create these two main objects and initializes the object system. Hence, the object of the ImageHandler class 1030 unpacks the Properties object and instantiates an object of the ImageLoader 1040 and instantiates an object of the ImageHandler class 1030.

During initialization, the object of the ImageHandler class 1030 loads the base map images, such as in action 610 in FIG. 6 and action 710 in FIG. 7. The loading transforms the data from the maps' raw data files and colormap files into BufferedImages. These large BufferedImages, along with the large BufferedImages created by the periodic loading of radar image data, wait in memory to be read by the image clip making process during user requests. The clip making process, bypasses the BufferedImage application program interface of Java and works directly with the data in the byte arrays.

In loading the base map images, as in image 810 in FIG. 8 and image 910 in FIG. 9, the object (not shown) of the ImageHandler class 1030 relies on functionality contained in an object (not shown) of the RawlmageTools class 1060. The object of the RawlmageTools class 1060 is a collection of static class methods useful for manipulating raw image files and color map configuration files. “Raw” image files are files in which each byte represents a single pixel and references the indexed color of that pixel. The map of indexes to colors is specified in a separate color map configuration file. The ImageLoader 1040 and ClipMaker 1050 classes also use the functionality of RawlmageTools 1060.

Periodic Loading of New Radar Image Data

The image loading process pre-supposes the existence of a process which supplies the imagery data. The data comes from a program which processes purchased data from a third party or from a program which processes the National Weather Services' Next Generation Weather Radar (NEXRAD) feed over access to NOAA real-time database system (NOAAPORT.) This external process places data into the proper location on the file system local to the objects of the server apparatus classes 1000.

The ImageLoader 1040 object is initialized with all information necessary to start and continue loading image data files on a periodic basis. The constructor for this class is the only public interface. During construction, an internal thread is started which loads the initial images and periodically checks the file system for new files. Enough images to form the image loop are loaded the first time through. When the ImageLoader 1040 object finds a new image file during the periodic check, it loads the image.

Image loading consists of the following:

Finding a file in a specific directory on the file system with a name consisting of the specified prefix, a timestamp for the file's contents, and a suffix of “.raw”. The file's timestamp must indicate a time following the last file which was loaded.

Decompressing the file's contents (it was compressed by the process with created it).

Reading the raw data from the file and combining it and a pre-configured color map into objects which comprise a BufferedImage object—IndexColorModel, DataBufferByte, and WriteableRaster.

Creating and returning the BufferedImage.

The date/time of each image is also extracted. The images and date/times are given to the object of the ImageHandler class 1030 for management. ImageHandler class 1030 does necessary scaling of the imagery to support the various map sizes, and constructs objects (not shown) of the MappedImage 1070 class and objects (not shown) of the MappedLoop class (not shown) for use by the ClipMaker object.

The MappedImage 1070 class consists of the image data for image and transformation information. The transformation information, in the form of an AffineTransfrom, maps latitude/longitude space to image pixel space. MappedLoop is similar to MappedImage 1070, but manages arrays of images rather than a single image.

Managing of Requests for Image Clips

ImageServlet 1010 doGet( ) class method is the HTTP GET interface: ImageServlet 1010 receives requests for image clips through this class method's “request” parameter; it sends responses, in known graphics formats such as PNG, JPEG, and GIF, back through the class method's “response” parameter. ImageServlet 1010 extracts the location and other image specifications from the request and hands most of the work of creating the image clip to the ImageHandler class 1030. ImageHandler class 1030 returns the data for the completed clip back in the form of a BufferedImage. ImageHandler class 1030 encodes the image data into the required graphics image format and returns the data to the requestor, as in action 630 in FIG. 6 and action 730 and FIG. 7.

The ImageHandler class 1030 getClip( ) class method uses the information contained in its parameter to request a clip of ClipMaker 1050. ClipMaker 1050 contains all necessary images, times, transformations, and color maps. The input to the clip making algorithm for each request are the parameters to the requestClip class method: 1) an array of locations, the first in the array specifying the center location; 2) the requested clip size of the image; 3) the scale of the image, where 100 represents the basic, agreed upon size (currently about 2 pixels to a kilometer), scale=50 is half that size, etc; 4) the timezone to use in making the time stamp on the image; and 5) a boolean indicating whether this will be a loop—an array of images, or not.

The final image will consist of the combining of three images—the underlying base map image, as in image 810 in FIG. 8 and image 910 in FIG. 9, the imagery, as in image 820 in FIG. 8 and image 910 in FIG. 9, and the overlay base map, as in image 840 in FIG. 8 and image 940 in FIG. 9, plus a timestamp and locations drawn on the image. The locations are represented by a hash mark on the exact location of the image, next to which is drawn the location name.

The underlying base map image is the part of the base map which lies underneath radar imagery, “overlay” parts will appear over the radar imagery. Land and lakes underlie the radar imagery, state lines, county lines, and interstates are overlaid on the radar imagery.

The three images are combined by the following method:

1. Obtain or create a byte array that will be the image data of the final image.

2. Obtain the appropriate three maps that will be the three layers, based on requested scale.

3. Using the requested image width and height, the image scale, and center location and the appropriate transformations, find pointers to first pixel to be used in each of the three layers.

4. For each pixel in the final image final, taking width and height into account:

Update pointers to the appropriate pixels of each layers.

Check the pixel in the topmost layer. If opaque, make that pixel's color the color of the pixel in the final image. This is done using pre-calculated mappings between the various images' color index tables.

If the pixel in the topmost layer is transparent, check the pixel in the second layer. If that is opaque, make that pixel's color the color of the pixel in the final image.

If the pixel in the second layer and the topmost layer are transparent, use the color of the pixel in the bottom layer for the color in the final image.

The resulting data structure is made into a BufferedImage by combining it with the appropriate IndexColorModel. Examples of the resulting data structure are image 850 in FIG. 8 and image 950 in FIG. 9. Using the BufferedImage API's drawstring( ) method, the time stamp and the location strings are drawn onto the image. The drawing of the location strings also involves an process for determining the placement of the locations and the strings and ensuring multiple locations do not overlap.

The resulting BufferedImage is returned and, as noted, converted to the appropriate graphics format before being sent back to the requester.

The apparatus 1000 components can be embodied as computer hardware circuitry or as a computer-readable program, or a combination of both. In another embodiment, apparatus 1000 is implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (A.P.I.) or interprocess communication techniques such as remote procedure call (R.P.C.), common object request broker architecture (CORBA), Component Object Model (COM), Distributed Component Object Model (DCOM), Distributed System Object Model (DSOM) and Remote Method Invocation (RMI). The components execute on as few as one computer as in computer 110 in FIG. 1, or on at least as many computers as there are components.

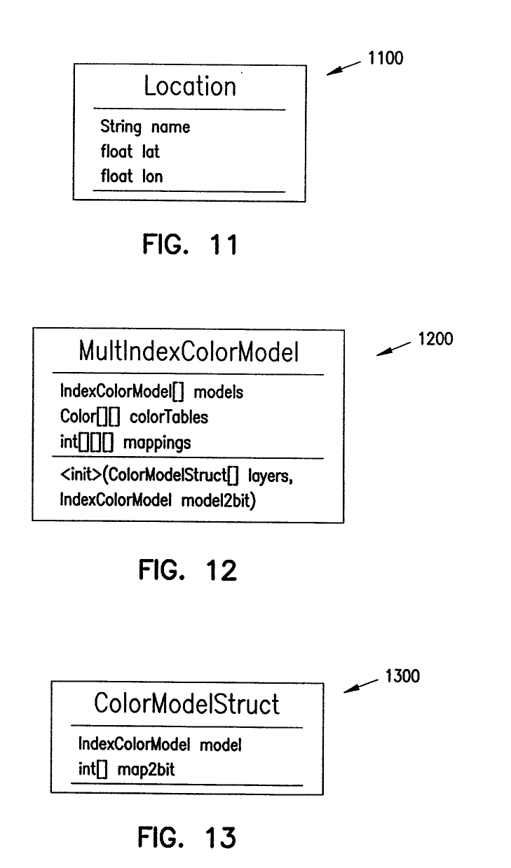

FIG. 11 is a block diagram of a server apparatus class 1100 for managing locations, according to an embodiment of the invention.

Each instance of the location class 1100 represents a single user location and consists of a location name and a latitude and longitude.

FIG. 12 is a block diagram of a server apparatus class 1200 for managing a multiple index color model, according to an embodiment of the invention.

Class MultIndexColorModel 1200 stores information about the various map and radar images' color models and mappings between color models. The MultIndexColorModel 1200 class implements IndexColorModel Java class that uses a limited set of discreet colors having reduced memory requirements. Other embodiments implement other ColorModel classes. IndexColorModels of varying bit sizes are implemented. I none embodiment, a ColorModel class with 256 colors requires eight bits (one byte) for each pixel in the image. In another embodiment, a ColorModel class with four colors requires two bits for each pixel is implemented.

FIG. 13 is a block diagram of a server apparatus class 1300 for managing a color model structure, according to an embodiment of the invention.

Class ColorModelStruct 1300 stores information about the various map and radar images' color models and mappings between color models. The ColorModelStruct class 1300 implements ColorModelStruct Java class that uses a limited set of discreet colors having reduced memory requirements. Other embodiments implement other ColorModel classes. IndexColorModels of varying bit sizes are implemented. In one embodiment, a ColorModel class with 256 colors requires eight bits (one byte) for each pixel in the image. In another embodiment, a ColorModel class with four colors requires two bits for each pixel.

### CONCLUSION

A method and apparatus for personal radar has been described.

Systems and methods are provided through which a radar image centered on a location of interest, is displayed. Alternatively, other predetermined personal locations that are within the range of the radar display are also displayed in the radar image. The personal locations are stored in a database, and the location of interest is selected from the personal locations. The radar image is dynamic, and changes when a different location of interest is selected from the list of personal locations. In another embodiment, the location of interest is the current physical location of the computer

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. For example, although described in object-oriented terms, one of ordinary skill in the art will appreciate that the invention can be implemented in a procedural design environment or any other design environment that provides the required relationships.

In particular, one of skill in the art will readily appreciate that the names of the methods and apparatus are not intended to limit embodiments of the invention. Furthermore, additional methods and apparatus can be added to the components, functions can be rearranged among the components, and new components to correspond to future enhancements and physical devices used in embodiments of the invention can be introduced without departing from the scope of embodiments of the invention. One of skill in the art will readily recognize that embodiments of the invention are applicable to future communication devices, different file systems, and new data types.

The terminology used in this application with respect to is meant to include all object-oriented, database and communication environments and alternate technologies which provide the same functionality as described herein. Therefore, it is manifestly intended that this invention be limited only by the following claims and equivalents thereof.

We claim:

1. A computerized method for a wireless client managing a personal phenomenological display comprising:
obtaining a location of the wireless client;
generating a first request to a server for geo-temporal information associated with the location; and
transmitting the first request.

2. The computerized method of claim 1, wherein obtaining a location of the client further comprises:
obtaining a location of the client from a determination of the cell of client.

3. The computerized method of claim 1, wherein obtaining a location of the client further comprises:
obtaining a location of the client from a global positioning system.

4. The computerized method of claim 1, the method further comprising:
updating the location when the client moves to another location;
generating a second request to a server for a graphic image of geo-temporal information centered on the updated location; and
transmitting the second request through the Internet.

5. The computerized method of claim 1, the method further comprising:
updating the location when the client moves to another location;
determining a speed and direction of movement of the client from the locations;
determining an estimated time of arrival the location of a geo-temporal condition from the speed and direction of movement of the client and the locations;
generating a report the of the estimated arrival at the location of a geo-temporal condition.

6. The computerized method of claim 1, obtaining a location of the wireless client further comprises:
receiving the location from user-entered information.

7. The computerized method of claim 1, wherein the client further comprises a wireless-application protocol-enabled mobile phone.

8. The computerized method of claim 1, wherein the client further comprises a personal digital assistant adapted for wireless Internet access.

9. The computerized method of claim 1, wherein the client further comprises a global positioning system device.

10. A computerized method for a client managing a personal phenomenological display comprising:
generating a first request for geo-temporal information of the location of the client, the request not including the location of the client;
transmitting the first request through the Internet to a server; and
receiving the geo-temporal information of the location, through the Internet from the server.

11. The computerized method of claim 10, the method further comprising:
updating the location when the client moves to another location;
generating a second request to a server for a graphic image of geo-temporal information centered on the updated location; and
transmitting the second request through the Internet.

12. The computerized method of claim 10, wherein the client further comprises a wireless-application protocol-enabled mobile phone.

13. The computerized method of claim 10, wherein the client further comprises a personal digital assistant adapted for wireless Internet access.

14. The computerized method of claim 10, wherein the client further comprises a global positioning system device.

15. A computerized method for a server managing phenomenological comprising:
receiving a first request for geo-temporal information of the location of a client, the request not including the location of the client;
receiving the location of the client from a communication service provider of the client; and
obtaining the geo-temporal information associated with the location of the client; and
transmitting the geo-temporal information associated with the location of the client, to the client.

16. The computerized method of claim 15, wherein the client further comprises a wireless-application protocol-enabled mobile phone and the communication service provider further comprises a cellular-based telephone system.

17. The computerized method of claim 15, wherein the client further comprises a personal digital assistant adapted for wireless Internet access, and the communication service provider further comprises an Internet service provider.

18. The computerized method of claim 15, wherein the client further comprises a global positioning system device.

19. The computerized method of claim 15, wherein the location further comprises a zip code.
